(19) United States
(12) Patent Application Publication
(10) Pub. No.: US 2025/0085547 A1
(43) Pub. Date: Mar. 13, 2025

(54) HEAD-UP DISPLAY

(71) Applicant: Panasonic Automotive Systems Co., Ltd., Kanagawa (JP)

(72) Inventors: Kousuke SASAKI, Kanagawa (JP); Kimihiro AOKI, Tokyo (JP)

(73) Assignee: Panasonic Automotive Systems Co., Ltd., Kanagawa (JP)

(21) Appl. No.: 18/776,979

(22) Filed: Jul. 18, 2024

(30) Foreign Application Priority Data
Sep. 11, 2023 (JP) 2023-146995

(51) Int. Cl. G02B 27/01; B60K 35/231; B60K 35/53

(52) U.S. Cl. CPC G02B 27/0172; B60K 35/231; B60K 35/53; G02B 27/0176; G02B 2027/011; G02B 2027/0154

(57) ABSTRACT

A head-up display includes: a combiner; a display device that emits display light representing information; and a housing that houses the display device. Furthermore, the combiner includes a first surface and a second surface on a back side of the first surface. Furthermore, a reflective film that reflects the display light emitted by the display device is provided on the first surface. Lastly, a low-reflective portion that has a reflectivity lower than a reflectivity of the first surface is provided on the second surface.

### CROSS REFERENCE TO RELATED APPLICATION

The present application is based on and claims priority of Japanese Patent Application No. 2023-146995 filed on Sep. 11, 2023.

### FIELD

The present disclosure relates to a head-up display.

### BACKGROUND

Patent literature (PTL) 1 discloses a head-up display device in which display contents of a display device are projected onto a combiner provided above an opening. A nontransparent black panel or a semi-light-transmissive black smoke panel is used in the combiner in the head-up display device.

PTL 2 discloses a head-up display device that includes a light-blocking cover formed from a material, such as a synthetic resin that is flexible.

### CITATION LIST

### Patent Literature

PTL 1: Japanese Unexamined Patent Application Publication No. 2016-132361
PTL 2: WO 2018/025741

### SUMMARY

However, the head-up display device in the above-mentioned PTL 1 can be improved upon.

However, the head-up display device in the above-mentioned PTL 2 can be improved upon.

In view of this, in the present disclosure, a head-up display that can further improve upon the related art is provided.

A head-up display according to one aspect of the present disclosure includes: a combiner; a display device that emits display light representing information; and a housing that houses the display device, wherein the combiner includes a first surface and a second surface on a back side of the first surface, a reflective film that reflects the display light emitted by the display device is provided on the first surface, and a low-reflective portion that has a reflectivity lower than a reflectivity of the first surface is provided on the second surface.

The head-up display according to the present disclosure can further improve upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram illustrating a usage example in which a head-up display according to an embodiment is viewed from the side.

FIG. 2 is a schematic diagram illustrating a usage example in which the head-up display according to the embodiment is viewed from inside a vehicle cabin.

FIG. 3A is a perspective view of the head-up display when a combiner is in an upright position.

FIG. 3B is a perspective view of the head-up display when the combiner is in a recumbent position.

FIG. 4A is a cross-sectional view of the head-up display taken along line A-A in FIG. 3A when the combiner is in the upright position.

FIG. 4B is a cross-sectional view of the head-up display taken along line B-B in FIG. 3B when the combiner is in the recumbent position.

FIG. 5 is a diagram illustrating display light that is reflected off of combiners.

### DESCRIPTION OF EMBODIMENT

Hereinafter, an embodiment will be described in detail with reference to the drawings.

It should be noted that the embodiment described below merely illustrates general or specific examples of the present disclosure. The numerical values, shapes, elements, arrangement, positions, and connection states of the elements, etc., described in the following embodiment are mere examples, and are therefore not intended to limit the present disclosure. Accordingly, among elements in the following embodiment, those not appearing in any of the independent claims will be described as optional elements.

It should be noted that the figures are schematic diagrams and are not necessarily precise illustrations. Therefore, for example, the scaling, and so on, depicted in the figures is not necessarily uniform. Moreover, elements that are substantially the same are given the same reference signs in the respective figures, and redundant descriptions may be omitted or simplified.

Furthermore, in the following embodiment, expressions such as “Y-axis direction”, “rectangular board-shaped”, and “approximately the same” are used. For example, “Y-axis direction”, “rectangular board-shaped”, or “approximately the same” not only mean exactly in the “Y-axis direction”, exactly in the shape of a “rectangular board”, or exactly “the same”, but also include substantially in the “Y-axis direction”, substantially in the shape of a “rectangular board”, or substantially “the same”, i.e., including an error of approximately several percent. In addition, “Y-axis direction”, “rectangular board-shaped”, and “approximately the same” mean in the “Y-axis direction”, “rectangular board-shaped”, or “approximately the same” to an extent that the advantageous effects of the present disclosure can be achieved. The same applies to other expressions using “direction”, “shaped”, and “approximately”.

### EMBODIMENT

### <Configuration>

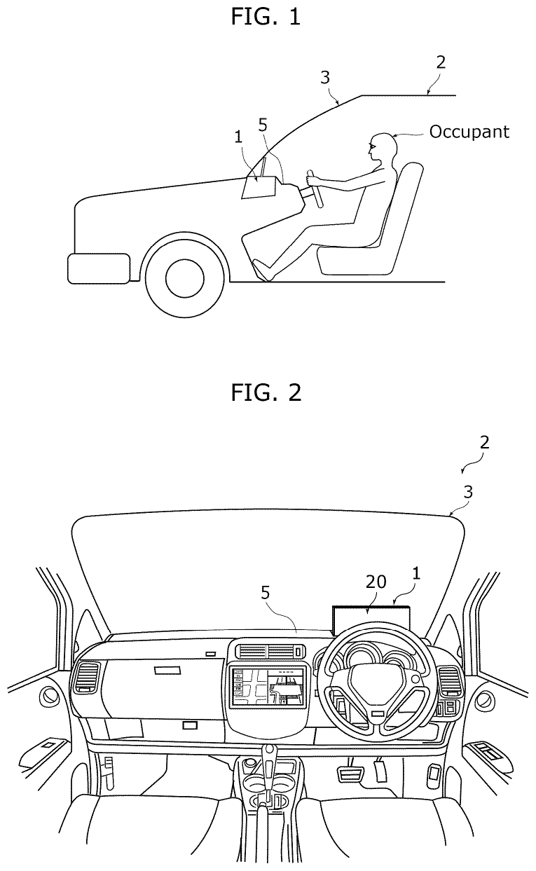

Hereinafter, head-up display 1 according to an embodiment will be described with reference to FIG. 1 through FIG. 4.

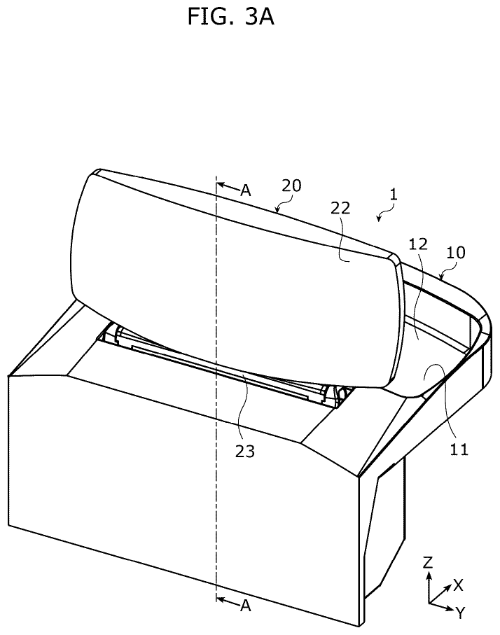

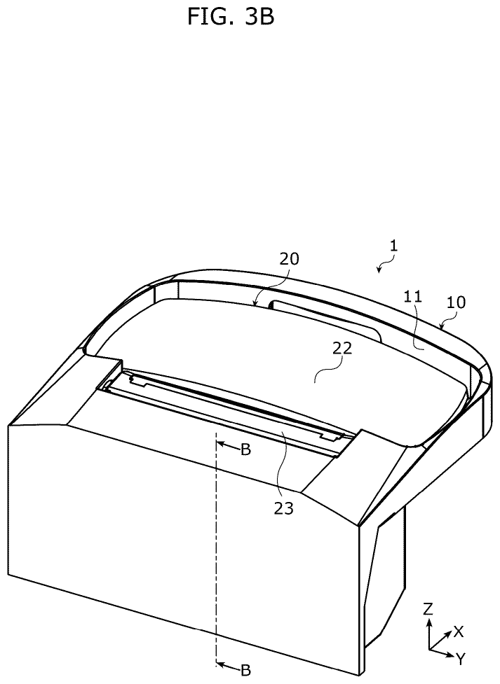

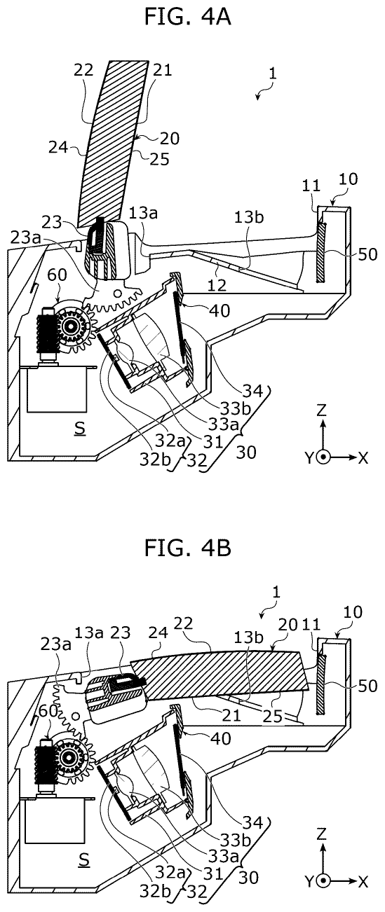

FIG. 1 is a schematic diagram illustrating a usage example in which head-up display 1 according to the embodiment is viewed from the side. FIG. 2 is a schematic diagram illustrating a usage example in which head-up display 1 according to the embodiment is viewed from inside a vehicle cabin. FIG. 3A is a perspective view of head-up display 1 when combiner 20 is in an upright position. FIG. 3B is a perspective view of head-up display 1 when combiner 20 is in a recumbent position. FIG. 4A is a cross-sectional view of head-up display 1 taken along line A-A in FIG. 3A when combiner 20 is in the upright position. FIG. 4B is a cross-sectional view of head-up display 1 taken along line B-B in FIG. 3B when combiner 20 is in the recumbent position.

As illustrated in FIG. 1 and FIG. 2, head-up display 1 is a device provided in vehicle 2. For example, head-up display 1 is provided in dashboard 5 of vehicle 2, which is an automobile or the like. Windshield 3 is provided above dashboard 5 (also referred to as an instrument panel) of vehicle 2. Combiner 20 of head-up display 1 is provided between dashboard 5 and windshield 3.

Head-up display 1 is a device that can project images onto combiner 20 for an occupant of vehicle 2. In other words, head-up display 1 displays, for the occupant, images displayed by a display light by causing the display light that the image is composed of being emitted by display device 30 to be projected onto combiner 20. The display light is light that represents image data including numbers, characters, figures, and the like, and is light that is displayed on combiner 20.

As illustrated in FIG. 3A through FIG. 4B, head-up display 1 includes housing 10, combiner 20, display device 30, frame 40, reflective mirror 50, and drive mechanism 60.

Housing 10 is an enclosure that houses combiner 20, reflective mirror 50, and display device 30. Housing 10 is fixed to vehicle 2 in a state where housing 10 is attached inside of dashboard 5 of FIG. 2. Housing 10 is made, for example, of a resin, such as polybutylene terephthalate (PBT).

Housing 10 is included as part of an outer shell of head-up display 1. Housing 10 is fixed to vehicle 2 when being equipped to dashboard 5 of FIG. 2.

Opening recessed portion 11 for positioning combiner 20 is provided in a central portion toward the positive side of the Z-axis direction of housing 10. Opening recessed portion 11 is provided with a size large enough to house combiner 20, which is rectangular board shaped, when combiner 20 is in a recumbent position.

Base plate 12 of opening recessed portion 11 blocks outside light that passes through opening recessed portion 11 of housing 10, and blocks stray light generated by display device 30. First penetrating hole 13a and second penetrating hole 13b are provided in base plate 12 of opening recessed portion 11.

Combiner 20 is provided inserted in first penetrating hole 13a. Specifically, since opening recessed portion 11 is configured such that combiner 20 can be provided in opening recessed portion 11, first penetrating hole 13a is provided so as to extend along the Y-axis direction so that rotating shaft 23 that is provided on one side of combiner 20 can be provided inserted in penetrating hole 13a. Although not shown in the figures, a shaft support for supporting rotating shaft 23 of combiner 20 in a rotatable manner is provided in housing 10.

Second penetrating hole 13b is provided toward the positive side of the X-axis direction relative to first penetrating hole 13a. Second penetrating hole 13b is provided penetrating through to allow display light emitted from display device 30 to pass through, and reach reflective mirror 50. Reflective mirror 50 is provided in second penetrating hole 13b.

Housing space S that communicates between opening recessed portion 11, first penetrating hole 13a, and second penetrating hole 13b is provided in housing 10. Display device 30, frame 40, reflective mirror 50, and drive mechanism 60 are housed in housing space S.

Display device 30 projects an image depicting information onto combiner 20 by emitting display light representing the information. Display device 30 is, for example, a liquid-crystal display device that has a liquid-crystal display or the like. Display device 30 housing includes component 31, light-emitting module 32, first collection lens 33a, second collection lens 33b, and exit surface 34.

Housing component 31 is a closed-bottom cylinder that has an opening toward the positive side of the X-axis direction. Housing component 31 houses light-emitting module 32, first collection lens 33a, second collection lens 33b, and the like. Housing component 31 is provided toward the negative side of the Z-axis direction relative to base plate 12, and is supported by housing 10 inside of housing space S.

Light-emitting module 32 includes light source 32a and substrate 32b.

Light source 32a is mounted on substrate 32b in an orientation in which light can be emitted toward exit surface 34 via first collection lens 33a and second collection lens 33b. Light source 32a includes, for example, a light-emitting diode (LED). Light source 32a is driven, for example, by direct-current power obtained from a power supply (not illustrated in the drawings) in vehicle 2. Light source 32a turns on and turns off by being controlled by a controller.

Light source 32a is mounted on a side of substrate 32b facing toward first collection lens 33a, second collection lens 33b, and exit surface 34.

Light emitted by light-emitting module 32 enters first collection lens 33a and second collection lens 33b. Accordingly, first collection lens 33a is supported by housing component 31 such that first collection lens 33a is facing toward light-emitting module 32, and second collection lens 33b is supported by housing component 31 such that second collection lens 33b is facing toward light-emitting module 32 with first collection lens 33a being interposed between second collection lens 33b and light-emitting module 32. In the present embodiment, first collection lens 33a and second collection lens 33b are supported by housing component 31 such that the central axis of first collection lens 33a, the central axis of second collection lens 33b, and the optical axis of light source 32a are in approximately the same orientation.

First collection lens 33a is a lens that collects light emitted from light source 32a and directs the light toward second collection lens 33b. First collection lens 33a is made of glass, a transparent resin, or the like.

Second collection lens 33b is a lens that collects light emitted from light source 32a transmitted via first collection lens 33a and directs the light toward exit surface 34. The light emitted by second collection lens 33b is emitted at the entire back side of exit surface 34.

Frame 40 is connected to an opening of housing component 31. Specifically, frame 40 is connected to housing component 31 so as to cover the opening toward the positive side of the X-axis direction of housing component 31. Frame 40 is a holding component for supporting exit surface 34 in a predetermined orientation.

An opening that allows the display light emitted through a surface of exit surface 34 to pass through is provided in frame 40. Exit surface 34 is attached to frame 40 so as to cover the opening of frame 40.

Exit surface 34 is a liquid-crystal display element, such as a liquid-crystal display (LCD). Exit surface 34 is, for example, a light-transmissive or semi-light-transmissive thin film transistor liquid-crystal display (TFT LCD) or the like. Exit surface 34 is driven by alternating-current power obtained from vehicle 2, As light is irradiated on the back side of exit surface 34, exit surface 34 allows the light transmitted to be emitted through the surface of exit surface 34. For example, exit surface 34 allows the display light that displays an image that includes numbers, characters, figures, and the like, to be emitted through the surface of exit surface 34 according to control instructions sent from the controller equipped in vehicle 2 of FIG. 1. The display light emitted through exit surface 34 reaches reflective mirror 50.

Reflective mirror 50 is provided in second penetrating hole 13b of housing 10 so as to reflect the display light emitted through exit surface 34 at combiner 20. Specifically, reflective mirror 50 is provided in housing 10 so as to be adjoining housing space S of housing 10 and opening recessed portion 11 of housing 10 and oriented approximately parallel to the Z-Y plane. Reflective mirror 50 is positioned below (toward the negative side of the Z-axis direction) combiner 20, and is positioned above (toward the positive side of the Z-axis direction) exit surface 34 and frame 40, in the Z-axis direction. In other words, reflective mirror 50 is provided between combiner 20 and exit surface 34, in the Z-axis direction.

Reflective mirror 50 reflects the display light emitted from display device 30 toward combiner 20. Specifically, reflective mirror 50 reflects the display light emitted from display device 30 toward first surface 21 of combiner 20, that is to say, the display light is projected at first surface 21 of combiner 20.

In the present embodiment, reflective mirror 50 is a convex mirror or a concave mirror that is elongated in the Y-axis direction and is rectangular. It should be noted that reflective mirror 50 is not limited to any particular shape, and may be polygonal, circular, or the like.

Accordingly, the display light emitted through exit surface 34 of display device 30 reaches and is reflected off of reflective mirror 50, and projected at reflective film 25 of combiner 20.

Combiner 20 is made of a nontransparent resin material. In the present embodiment, combiner 20 is made of a black polycarbonate resin. It should be noted that the nontransparent resin material is not limited to black polycarbonate resin. For example, acrylic, cyclic olefin copolymer (COC resin), or the like may be used as the nontransparent resin material. Since combiner 20 is nontransparent, combiner 20 is configured such that the occupant cannot view the direction of travel of vehicle 2 through combiner 20.

Combiner 20 is a display panel that displays images by projection of the display light reflected by reflective mirror 50. Although combiner 20 is approximately rectangular, combiner 20 is not limited to any particular shape, and may be polygonal, circular, or the like.

Combiner 20 is reclinable. As described above, since combiner 20 includes rotating shaft 23 that is rotatably and axially supported by the shaft support of housing 10, combiner 20 can switch between an upright position where combiner 20 stands upright relative to opening recessed portion 11, and a recumbent position where combiner 20 is laid down relative to the upright position. When combiner 20 is in the upright position, combiner 20 is held by housing 10 in the upright position relative to the opening surface of opening recessed portion 11. When combiner 20 is in the upright position, first surface 21 of combiner 20 faces toward the occupant of vehicle 2. Furthermore, when combiner 20 is in the recumbent position, second surface 22 of combiner 20 is disposed on the top side of head-up display 1, and combiner 20 is held by housing 10 in a stored state so as to be stored in opening recessed portion 11 of housing 10. When combiner 20 is in the recumbent position, second surface 22 is located in a position above first surface 21 so as to be visible to the occupant. The upright position is an orientation in which the surfaces of combiner 20 are approximately parallel to the Z-Y plane, and combiner 20 is in a standing state relative to opening recessed portion 11. The recumbent position is an orientation in which first surface 21 of combiner 20 is approximately parallel to the X-Y plane, and combiner 20 is in a stored state relative to opening recessed portion 11.

Rotating shaft 23 of combiner 20 is a rod-shaped shaft that is elongated in the Y-axis direction. Rotating shaft 23 is supported by housing 10 about an axis that is approximately parallel to the Y-axis direction. Rotating shaft 23 includes gear 23a that is rotated by the driving force of drive mechanism 60. Gear 23a of rotating shaft 23 interlocks with the intermittent gear of drive mechanism 60, and rotating shaft 23 is rotated by drive mechanism 60. Accordingly, combiner 20 switches between the upright position and the recumbent position.

Combiner 20 includes first surface 21 and second surface 22 on the back side of first surface 21.

First surface 21 is a surface on which the display light reflected by reflective mirror 50 is incident, and is also the surface facing the positive side of the X-axis direction and is facing toward the occupant, as well as the projection surface on which the display light reflected by reflective mirror 50 is incident.

Reflective film 25 that reflects the display light emitted from display device 30 is provided on first surface 21. Reflective film 25 is a film that can further reflect the display light reflected by reflective mirror 50. Reflective film 25 is, for example a light-reflective film that includes aluminum, silver, or the like, that has been deposited on first surface 21. In order to deposit reflective film 25 on first surface 21, first surface 21 has a mirror finish.

Low-reflective portion 24 that has a reflectivity lower than a reflectivity of first surface 21 is provided on second surface 22. In other words, second surface 22 has a low-reflective coating. Low-reflective portion 24 may have a light-diffusing function or may have a light-absorbing function. Accordingly, low-reflective portion 24 can suppress reflection of incident outside light directed toward the occupant.

Low-reflective portion 24 may be provided by applying a coating on second surface 22. Gloss of low-reflective portion 24 is no more than 0.6. When combiner 20 is in the recumbent position in a case where gloss is no more than 0.6, even if outside light becomes incident on the back side of combiner 20, since reflection of the outside light can be suppressed, the likelihood of the light reflected by the back side of combiner 20 entering the eyes of the occupant can be reduced. It should be noted that it is preferable that gloss of low-reflective portion 24 is no more than 0.4. This would further reduce the likelihood of the light reflected by the back side of combiner 20 entering the eyes of the occupant.

Furthermore, low-reflective portion 24 may be provided by performing a texture treatment process on second surface 22. A surface roughness of low-reflective portion 24 imparted by performing the texture treatment process is at least 50 μm and at most 70 μm. Specifically, the surface roughness may be 60 μm. When the surface roughness of low-reflective portion 24 is at least 50 μm and at most 70 μm, even if low-reflective portion 24 gets scratched by a hand of the occupant or the like coming into contact with low-reflective portion 24, it is possible to prevent the scratch from becoming noticeable. It should be noted that in a case where a hand of the occupant or the like would not come into contact with low-reflective portion 24, the surface roughness of low-reflective portion 24 may be set to between 10 μm and 15 μm, inclusive.

Combiner 20 is a convex plate or a concave plate. Accordingly, a curvature of first surface 21 is different from a curvature of second surface 22.

In the present embodiment, first surface 21 is a flat surface and second surface 22 is a curved surface. Second surface 22 is curved to bulge toward the direction of windshield 3 relative to combiner 20, or in other words, second surface 22 is curved to bulge toward the negative side of the X-axis direction. When combiner 20 is in the upright position, first surface 21 and second surface 22 are oriented so as to incline upward toward the positive side of the X-axis direction relative to the Z-Y plane. It should be noted that second surface 22 may curve so as to recede toward the negative side of the X-axis direction.

Furthermore, first surface 21 may be a curved surface and second surface 22 may be a flat surface. In this case, first surface 21 may curve so as to recede toward the negative side of the X-axis direction. It should be noted that first surface 21 may curve so as to bulge toward the negative side of the X-axis direction.

Drive mechanism 60 causes combiner 20 to recline. Drive mechanism 60 may cause combiner 20 to switch between the upright position and the recumbent position by causing rotating shaft 23 of combiner 20, which is axially supported by the shaft support of housing 10, to rotate. Drive mechanism 60 includes a motor, an intermittent gear, or the like, for example.

### <Operation>

Next, the operation of head-up display 1 according to the present embodiment will be described.

In head-up display 1 configured in this manner, light that is emitted from light source 32a of display device 30 passes through first collection lens 33a and second collection lens 33b, and irradiates the back side of exit surface 34. Accordingly, display light that displays an image is emitted through the surface of exit surface 34. The display light emitted through exit surface 34 of display device 30 reaches and is reflected off of reflective mirror 50, and projected at reflective film 25 of combiner 20. The display light that is incident on reflective film 25 is reflected by reflective film 25 and directed toward the occupant. In other words, in head-up display 1, the display light that displays an image is reflected toward the occupant by being projected onto combiner 20. Accordingly, by displaying the image on combiner 20 to be viewed by the occupant, it is possible for the occupant to view the image displayed on combiner 20 together with the scenery beyond windshield 3 in the direction of travel of vehicle 2.

### <Functions and Effects>

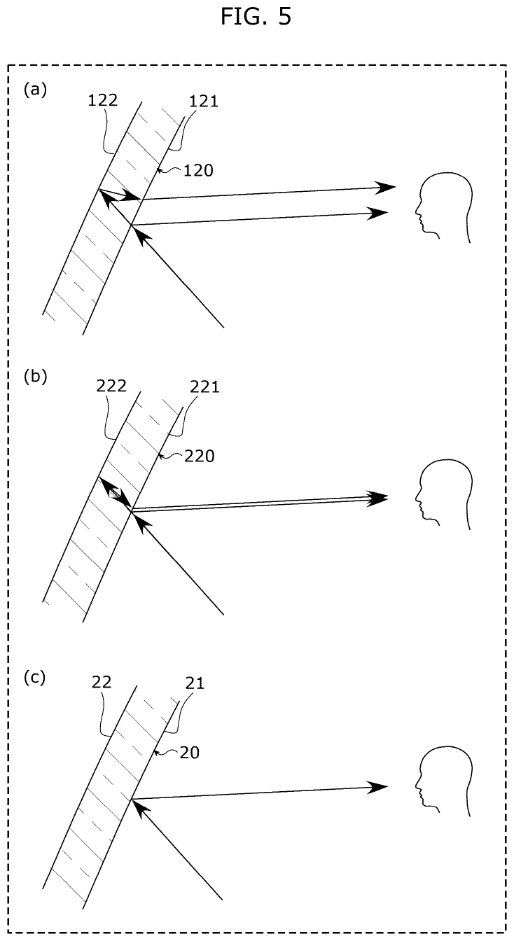

Next, the functions and effects of head-up display 1 according to the present embodiment will be described. It should be noted that the functions and effects of head-up display 1 according to the present embodiment may be described with reference to FIG. 5. FIG. 5 is a diagram illustrating display light that is reflected off of combiner 20, combiner 120, and combiner 220. (a) in FIG. 5 illustrates a situation, in a conventional combiner 120, in which the first-order reflected display light reflected by first surface 121 and the second-order reflected display light reflected by second surface 122 are reflected toward an occupant. (b) in FIG. 5 illustrates a situation, in a conventional combiner 220, in which the first-order reflected display light reflected by first surface 221 and the second-order reflected display light reflected by second surface 222 are reflected toward an occupant. (c) in FIG. 5 illustrates a situation, in combiner 20 according to the present embodiment, in which the first-order reflected display light reflected by reflective film 25 of first surface 21 is reflected toward an occupant.

In conventional head-up display devices, since the combiner is a nontransparent black panel or a semi-light-transmissive black smoke panel, when the combiner is reclined, outside light may be reflected off of the back side of the combiner. Is this case, light reflected off of the back side or the like of the combiner may enter the eyes of the occupant. In view of this, when the combiner is reclined, the light reflected off of the back side of the combiner may conceivably be prevented from entering the eyes of the occupant by covering the back side of the combiner with a cover.

Furthermore, in conventional head-up display devices, a separate cover for covering the combiner is provided in the head-up display, or a drive mechanism for driving the cover is provided in the head-up display. In this case, it is problematic that the structure of the head-up display becomes more complex or the size of the head-up display becomes larger due to an increase in the number of components used.

In view of this, as described above, head-up display 1 according to technique 1 of the present embodiment includes combiner 20, display device 30 that emits display light representing information, and housing 10 that houses display device 30. Furthermore, combiner 20 includes first surface 21 and second surface 22 on a back side of first surface 21. Furthermore, reflective film 25 that reflects the display light emitted by display device 30 is provided on first surface 21. Lastly, low-reflective portion 24 that has a reflectivity lower than a reflectivity of first surface 21 is provided on second surface 22.

Accordingly, when combiner 20 is in a recumbent position, although second surface 22 is irradiated by outside light due to second surface 22 being located in a position above first surface 21, since low-reflective portion 24 is provided on second surface 22, low-reflective portion 24 can suppress reflection of the outside light even when the outside light is incident on low-reflective portion 24. Thus, the likelihood of the outside light incident on low-reflective portion 24 directly reaching the eyes of an occupant can be reduced. Accordingly, even when combiner 20 is in a recumbent position, a separate cover to cover second surface 22 does not need to be provided, and a drive mechanism for driving the cover does not need to provided.

Consequently, the head-up display 1 according to the present disclosure can simplify the structure of head-up display 1 and limit the size of head-up display 1.

Furthermore, head-up display 1 according to technique 2 of the present embodiment is head-up display 1 according to technique 1, in which low-reflective portion 24 is provided by applying a coating to second surface 22.

Accordingly, by applying a coating to second surface 22, low-reflective portion 24 can easily be provided. Thus, it is possible to both simplify the structure of head-up display 1 and limit the size of head-up display 1.

Furthermore, head-up display 1 according to technique 3 of the present embodiment is head-up display 1 according to technique 1 or 2, in which combiner 20 includes a nontransparent resin material, and low-reflective portion 24 is provided by performing a texture treatment process on second surface 22.

Accordingly, by performing a texture treatment process on second surface 22 of combiner 20, which is made of a nontransparent resin material, low-reflective portion 24 can easily be provided. Thus, it is possible to both simplify the structure of head-up display 1 and limit the size of head-up display 1.

Furthermore, as illustrated in (a) in FIG. 5, with conventional combiner 120, since first-order reflected display light reflected by first surface 121 and second-order reflected display light reflected by second surface 122 are reflected toward an occupant, the virtual images appear to the occupant to be overlapping each other. In view of this, as illustrated in (b) in FIG. 5, second-order reflection caused by second surface 222 may conceivably be controlled through optical design of second surface 222 for controlling second-order reflection as seen in conventional combiner 220. In this case, manufacturing costs of combiner 220 would increase due to forming related difficulties, long cooling times, or the like. As an alternate method, an anti-reflection coating (AR coating) treatment may conceivably be performed on second surface 222 to alleviate the issue of overlapping images by aligning the first-order reflected display light reflected by first surface 221 and the second-order reflected display light reflected by second surface 222. However, even in this case, the issue of the overlapping images would be difficult to eliminate, and the manufacturing costs of combiner 220 would increase by the amount of cost of the AR coating.

However, as illustrated in (c) in FIG. 5, in the present embodiment, since combiner 20 includes a nontransparent resin material, the display light does not penetrate combiner 20, and only the first-order reflected display light reflected by reflective film 25 of first surface 21 is reflected toward an occupant. Accordingly, it is possible to alleviate the difficulty related to forming combiner 20, while also preventing the occurrence of overlapping images despite maintaining a simple configuration.

Furthermore, head-up display 1 according to technique 4 of the present embodiment is head-up display 1 according to technique 1 or 2, in which a surface roughness of low-reflective portion 24 imparted by performing the texture treatment process is at least 50 μm and at most 70 μm.

Accordingly, when combiner 20 is in a recumbent position, even if low-reflective portion 24 is scratched due to low-reflective portion 24 coming into contact with a hand or the like of an occupant, it is possible to prevent the scratch from becoming noticeable.

Furthermore, head-up display 1 according to technique 5 of the present embodiment is head-up display 1 according to any one of techniques 1 to 4, in which gloss of low-reflective portion 24 is no more than 0.6.

Accordingly, when combiner 20 is in a recumbent position, even if outside light is incident on low-reflective portion 24, low-reflective portion 24 can suppress reflection of the outside light. Thus, the likelihood of the outside light incident on low-reflective portion 24 directly reaching the eyes of an occupant is further reduced. As a result, it is possible to both simplify the structure of head-up display 1 and limit the size of head-up display 1.

Furthermore, head-up display 1 according to technique 6 of the present embodiment is head-up display 1 according to any one of techniques 1 to 5, in which a curvature of first surface 21 is different from a curvature of second surface 22.

Accordingly, since first surface 21 is optically designed so as to reflect the display light toward an occupant, while first surface 21 will need to be set in advance with a curvature, second surface 22 will not need to be set in such a manner. Thus, since the curvature of second surface 22 can be changed as needed, if the curvature of second surface 22 is set to follow the shape of dashboard 5 in which head-up display 1 is provided, when combiner 20 is in a recumbent position, head-up display 1 can be integrated with dashboard 5 and made to be less noticeable.

Furthermore, head-up display 1 according to technique 7 of the present embodiment is head-up display 1 according to any one of techniques 1 to 6, in which combiner 20 is reclinable.

Accordingly, by placing combiner 20 in a recumbent position while combiner 20 is not being used, the field of vision when viewing windshield 3 can be maintained, while integrating combiner 20 with dashboard 5. Furthermore, by placing combiner 20 in an upright position, images can be displayed on combiner 20.

Furthermore, head-up display 1 according to technique 8 of the present embodiment is head-up display 1 according to any one of techniques 1 to 7, in which reflective film 25 is a half mirror.

Accordingly, since reflectance of the display light incident on reflective film 25 can be suppressed, glare of the image displayed by the display light projected on combiner 20 can be suppressed. Thus, an occupant can more readily recognize the image projected on combiner 20.

Furthermore, head-up display 1 according to technique 9 of the present embodiment is head-up display 1 according to any one of techniques 1 to 8, in which head-up display 1 is provided in vehicle 2, combiner 20 switches between an upright position where combiner 20 stands upright and a recumbent position where combiner 20 is laid down relative to the upright position, when combiner 20 is in the upright position, first surface 21 faces toward an occupant of vehicle 2, and when combiner 20 is in the recumbent position, second surface 22 is located in a position above first surface 21.

Thus, when combiner 20 is in the recumbent position, since low-reflective portion 24 is positioned on top, the likelihood of the outside light incident on low-reflective portion 24 directly reaching the eyes of the occupant is reduced. Accordingly, even when combiner 20 is in the recumbent position, a separate cover to cover second surface 22 does not need to be provided, and drive mechanism 60 for driving the cover does not need to provided.

Furthermore, when combiner 20 is in the upright position, images can be displayed on combiner 20. Accordingly, the occupant can recognize the images displayed on combiner 20.

### (Other Variations)

While the head-up display according to the present disclosure has been described based on the above-mentioned embodiment, the present disclosure is not limited to this embodiment. The present disclosure may include forms obtained by various modifications to the foregoing embodiment that can be conceived by those skilled in the art, for as long as they do not depart from the essence of the present disclosure.

Furthermore, in the head-up display according to the present embodiment, a light-transmissive cover may be attached to an opening of the frame. In other words, the light-transmissive cover may be provided in the frame in an orientation so as to face the exit surface of the display device, and the light-transmissive cover may cover the exit surface of the display device. In this case, the light-transmissive cover functions as an anti-staining cover that prevents dust, debris, and the like from reaching the exit surface of the display device.

It should be noted that the present disclosure includes forms obtained by making various modifications to the above-described embodiment that can be conceived by those skilled in the art, as well as forms realized by arbitrarily combining elements and functions in different embodiments without materially departing from the essence of the present disclosure.

While an embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in its entirety: Japanese Patent Application No. 2023-146995 filed on Sep. 11, 2023.

### INDUSTRIAL APPLICABILITY

The present disclosure is, for example, applicable to moving bodies, such as vehicles or the like.

1. A head-up display comprising:
a combiner;
a display device that emits display light representing information; and
a housing that houses the display device, wherein
the combiner includes a first surface and a second surface on a back side of the first surface,
a reflective film that reflects the display light emitted by the display device is provided on the first surface, and
a low-reflective portion that has a reflectivity lower than a reflectivity of the first surface is provided on the second surface.

2. The head-up display according to claim 1, wherein
the low-reflective portion is provided by applying a coating to the second surface.

3. The head-up display according to claim 1, wherein
the combiner includes a nontransparent resin material, and
the low-reflective portion is provided by performing a texture treatment process on the second surface.

4. The head-up display according to claim 3, wherein
a surface roughness of the low-reflective portion imparted by performing the texture treatment process is at least 50 μm and at most 70 μm.

5. The head-up display according to claim 1, wherein
gloss of the low-reflective portion is no more than 0.6.

6. The head-up display according to claim 1, wherein
a curvature of the first surface is different from a curvature of the second surface.

7. The head-up display according to claim 1, wherein
the combiner is reclinable.

8. The head-up display according to claim 1, wherein
the reflective film is a half mirror.

9. The head-up display according to claim 1, wherein
the head-up display is provided in a vehicle,
the combiner switches between an upright position where the combiner stands upright and a recumbent position where the combiner is laid down relative to the upright position,
when the combiner is in the upright position, the first surface faces toward an occupant of the vehicle, and
when the combiner is in the recumbent position, the second surface is located in a position above the first surface.
